(19) United States
(12) Patent Application Publication
(10) Pub. No.: US 2011/0259186 A1
(43) Pub. Date: Oct. 27, 2011

(54) BALLISTIC COLLAR

(75) Inventor: Pim Rensink, Utrecht (NL)

(73) Assignee: Nederlandse Organisatie voor toegepast-natuurwet onderzoek TNO, Delft (NL)

(21) Appl. No.: 13/125,584

(22) PCT Filed: Oct. 23, 2009
(86) PCT No.: PCT/NL2009/050645

§ 371 Date: Jul. 8, 2011

(30) Foreign Application Priority Data
Oct. 23, 2008 (EP) 08167457.4

(51) Int. Cl. F41H 1/02; B23P 11/00; D05B 1/00; F41H 5/04

(52) U.S. Cl. 89/36.02; 89/36.05; 29/428; 112/475.01; 89/921; 89/926; 89/904; 89/914; 89/916; 89/915

(57) ABSTRACT

Ballistic collar comprising a bellows shaped member (1) which is arranged to surround a human's neck, comprising bellows plies (2, 3) being mainly perpendicular to the axis of the collar or of the human's neck. Free standing, the structure stands up around the neck to provide ballistic protection. The structure may be formed by folding a sheet of ballistic rated body armor fabric comprising strong synthetic fibers, e.g. from aromatic polyamide fibers, or ultra high molecular weight polyolefin, e.g. polyethylene polypropylene, fibers. For manufacturing the ballistic collar a plurality of sheets may be piled-up and the whole may be submitted to transformation in a mold (5, 6) at a temperature and pressure at which the sheets remain mainly loose from each other. Preferably parts of the collars or bellows shaped members are made, which are assembled afterwards e.g. by stitching, welding etc.

### FIELD OF THE INVENTION

The invention relates to a ballistic collar, i.e. a collar which is intended for protection against bullets, shrapnel etc and a method of manufacturing such a collar. An embodiment of the invention relates to a ballistic neck collar, for protection of the neck.

### BACKGROUND

EP 1533587 describes body protection by means of rigid armour plates. The document notes that such plates can hinder motion, for example when the bearer has to assume a crouching stances. To allow for an easily deformable body protection a plurality of overlapping plates is used, with variable overlap between the plates. The variable overlap is made possible by connections with pegs between successive pairs of plates, the peg being hingingly connected to one plate and sliding in a slot in the other plate. The document mentions that the plate assembly can protect an operative's neck, chest and abdomen.

In times of war many soldiers are killed or wounded by injuries of their face or neck. Besides the face, the neck is a weak point in the ballistic protection of soldiers. Due to the high extent of mobility of the head and the properties of the present ballistic materials and manufacturing methods it is hard to make a neck protection which does not hinder the head movements and nevertheless provides a good ballistic protection level including a sufficient protection surface.

Present neck protection collars are a compromise of both: a certain extent degree of protection and a certain degree of flexibility, however, both being unsatisfactory. The interaction between de ballistic neck protection and the ballistic helmet causing mobility when the soldier is in prone position, while in standing position an ballistic gap may be formed between the helmet and the collar.

U.S. Pat. No. 4,324,003 describes a throat guard for protecting the neck for sportsmen. The throat guard comprises a series of overlapping rigid U-shaped bands. The uppermost band is suspended from the head of the wearer and the lowermost band is attached at chest level. The overlapping U-shaped bands provide for a combination of protection and flexibility, reducing or increasing the overlap with movement of the head. However, the need to suspend the bands from the head makes wearing cumbersome and reduces the freedom of motion of the head.

### SUMMARY

It is an object to provide a ballistic collar that combines good ballistic protection with freedom of movement. A ballistic neck protection with freedom of movement of a soldier's head may be provided for example.

A ballistic collar is provided that comprises a body armour fabric folded into a structure with successive strips that run over into each other by folds of the fabric, the folds running substantially perpendicularly to an axial direction of the collar, whereby the collar may be expanded or compressed by increasing or decreasing fold angles between the strips at the folds. Thus a shape as in the compressible and expandable part of an accordion is realized, or in the bellows that used to be used in photographic cameras. This provides for a structure that stands up freely and can be compressed and expanded. In an embodiment the fabric is included in a matrix, such as a resin, preferably a resilient resin with sufficient stiffness sufficient to cause the structure to stand up freely in a compressible position.

It is preferred that the ballistic collar comprises a structure which is arranged to surround a human's neck. It is preferred that the plies of the structure are mainly perpendicular to the axis of the collar or of the human's neck. Besides, it is preferred that the structure is formed by a plurality of piled sheets.

As will be elucidated below, the shape of the proposed collar enables shortening and lengthening of the collar when the soldier's head moves upward-downward and/or left-right. Due to the (pre-)tension in the material the collar will always push itself upward, causing an optimal protection area at all sides, while the head is not hindered in its upward-downward or left-right movements.

The plurality of sheets preferably comprise sheets made of a ballistic rated body armor fabric comprising strong synthetic fibers, like aromatic polyamide fibers e.g. like Kevlar™ or Twaron™ However, the strong synthetic fibers may comprise, alternatively, ultra high molecular weight polyolefin (UHMWPO) fibers (see e.g. U.S. Pat. No. 6,916,533), e.g. ultra high molecular weight polyethylene (UHMWPE) fibers like e.g. Dyneema™ or Spectra™ or ultra high molecular weight polypropylene (UHMWPP) fibers e.g. Pure™.

A method for manufacturing a ballistic collar or at least the bellows shaped member preferably comprises the steps of

providing a sheet to be used for the relevant ballistic collar;

providing a mold arranged for sheet transformation, defining the shape of the ballistic collar;

performing transformation of sheet at a temperature and pressure at which the sheets are deformable.

Thermoforming may be used for example or deep drawing. It may be preferred to thermoform parts of the collars first and to assemble the parts of the collars together e.g. by stitching, welding etc.

### BRIEF DESCRIPTION OF THE DRAWING

These and other objects and advantageous aspects will become apparent from a description of exemplary embodiments, using the following figures.

FIG. 1 shows an exemplary embodiment of a ballistic collar

FIG. 2 gives an illustration of the manufacturing process of the ballistic collar

### Detailed description of exemplary embodiments

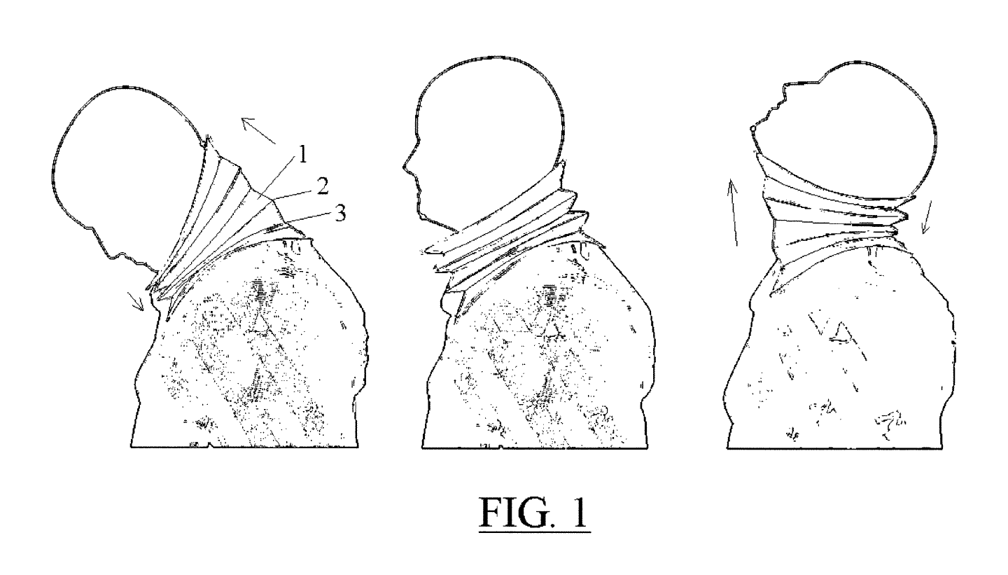

FIG. 1 shows a ballistic collar which comprises a bellows shaped member 1 which is arranged to surround a human's neck. By way of example a soldier is shown wearing the collar. As used herein the term bellows shape refers to the type of shape that is shown in FIG. 1, as can be found in the bellows of accordion (in Dutch also called trek-harmonica) or old-fashioned photographic cameras.

Such a bellows shape is a folded structure with folds that connects plies, i.e. strips that are part of the folded structure. In a bellows shape the structure forms an expandable and compressible cylinder wall (not necessarily circular) formed by strips and folds extending perpendicularly to the axis of the cylinder. The structure has successive strips that run over into each other by folds of the fabric, the folds running substantially perpendicularly to an axial direction of the collar, whereby the collar may be expanded or compressed by increasing or decreasing angles between the strips at the folds. The fabric is preferably included in a matrix, such as a resilient resin, with sufficient stiffness sufficient to cause the structure to stand up freely in a compressible position.

In the embodiment shown in FIG. 1 the bellows folds 2 and 3 of the bellows shaped member run mainly perpendicular to the axis of the collar or—when in use—of the human's neck.

Expansion occurs when the fold angles open up (when the angle between the strips increases). Compression occurs when the folds angles narrow (when the angle between the strips decreases). When no dynamic force is exerted (just gravity) the bellows assumes an unloaded position with a non-zero fold angle between the strips.

The collar may be formed from one or more piled sheets of a ballistic rated body armour fabric in a matrix of resilient resin. The one or more sheets are folded into the bellows shaped structure. The resilient resin may be rubber or synthetic rubber for example. The matrix serves to preserve the folds in the fabric in the bellows shaped structure and to provide for expandability and compressibility of the bellows. In addition, when a plurality of sheets is used, the matrix binds the piled sheets.

The bellows shaped member may be formed from one or more sheets made of a ballistic rated body armour fabric comprising strong synthetic fibers, e.g. comprising aromatic polyamide fibers, ultra high molecular weight polyolefin, e.g. polyethylene or polypropylene fibers. The sheet of fibers may be embedded in resin, preferably resilient resin, such as rubber or synthetic rubber to form the matrix. The sheet may be folded to pre-form the bellows shape. Preferably, the combination of the folded sheet and resin is formed into the folded structure when the resin is in a plastically deformable state (e.g. heated or before curing of the resin), so that it undergoes a transition to a substantially only elastically deformable state afterwards (a substantially not plastically deformable state). Thus an unloaded state of the bellows structure can be realized wherein the bellows stands up in a position from which it can be compressed or expanded as a result of movement. The height of the structure preferably equals the height of the structure to be protected, such as the average height of the human neck. A mold may be used to perform the folding. The resin may be cured after folding, or cooled from a thermoplastic state.

In an embodiment ends of the folded structure that extend parallel to the axis of the cylinder may be assembled e.g. by stitching, welding etc. after the folded structure has been formed. A one piece structure may be used, which loops around full circle to these ends. Alternatively a multi-piece structure may be used, with a plurality of assembly lines (e.g. stitching lines or weld lines) parallel to the axis of the cylinder at a plurality of positions in its circumference in a plane perpendicular to the axis.

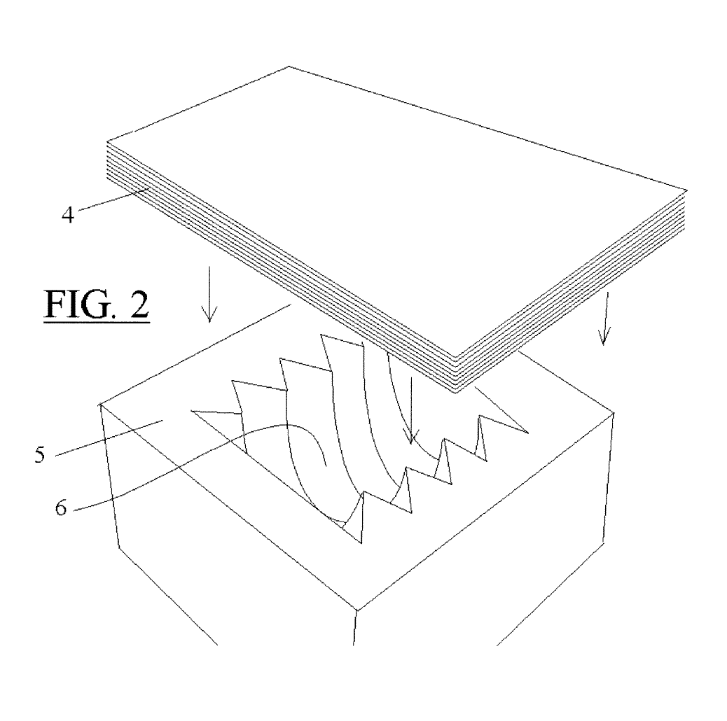

In an embodiment the bellows shaped member may be formed from a pile of a plurality of sheets 4, as shown in FIG. 2. The sheets are made of a ballistic rated body armor fabric comprising strong synthetic fibers, e.g. comprising aromatic polyamide fibers, ultra high molecular weight polyolefin, e.g. polyethylene or polypropylene fibers.

A method of manufacturing the ballistic collar or at least the bellows shaped member is schematically illustrated in FIG. 2, showing a piled of a plurality of thermoplastically deformable sheets 4 which are used as semimanufacture for manufacturing the ballistic collar or bellows shaped member. A mold 5 is provided, arranged for sheet transformation (incl. vacuum forming, blow molding etc.), which mold 5 has the shape of the (exterior of the) ballistic collar or bellows shaped member respectively or of a part of it. The mold can be a “positive mold” as illustrated in FIG. 2 or a “negative mold” (not shown).The sheets 4 are heated (by not shown heating means) and the transformation of the piled plurality of sheets is performed at a temperature and pressure at which the sheets remain mainly loose from each other, viz. below the melting temperature of the sheet material(s) but at a temperature and pressure level at which the sheets are weakened enough to be deformed smoothly in the (evacuated) mold cavity 6.

If the sheets, despite the precautions, would still stick together during deformation in the mold, the stacked sheets could be alternated with non-sticking sheets, e.g. made from PTFE (“Teflon”). An alternative would be to mold all separate sheets separately, instead of as stack-wise, and to assemble them together afterward.

In FIG. 2 a half bellows member can be made. Two of such half members can afterwards be assembled to a complete bellows member by e.g. welding (i.e. melting) or stitching the half bellows members together at their borders, thus forming in a neck surrounding ballistic collar having excellent properties, viz. combining excellent ballistic and ergonomic properties.

A ballistic collar is provided that comprises a bellows shaped member member (1) (also called accordion shaped member or harmonica shaped member, in view of the Dutch “trek-harmonica), which is arranged to surround a human's neck. In an embodiment the bellows plies (2, 3) of the bellows shaped member may be mainly perpendicular to the axis of the collar or of the human's neck. In an embodiment the bellows shaped member may be formed by a plurality of piled sheets (4). In a further embodiment the plurality of sheets comprising sheets made of a ballistic rated body armor fabric comprising strong synthetic fibers. In an embodiment the strong synthetic fibers may comprise aromatic polyamide fibers. In an embodiment the strong synthetic fibers may comprise ultra high molecular weight polyolefin (UHMWPO) fibers. In an embodiment the strong synthetic fibers comprising ultra high molecular weight polyethylene (UHMWPE) fibers. In an embodiment the strong synthetic fibers may comprise ultra high molecular weight polypropylene (UHMWPP) fibers.

In an embodiment a method of manufacturing a ballistic collar or at least the bellows shaped member according comprises: providing and piling up a plurality of sheets to be used for the relevant ballistic collar or bellows shaped member; providing a mold (5, 6) arranged for sheet transformation, having the shape of the ballistic collar or bellows shaped member respectively or of a part of it; performing transformation of the piled plurality of sheets at a temperature and pressure at which the sheets remain mainly loose from each other. In an embodiment the method comprises transforming parts of the collars or bellows shaped members; assembling the parts of the collars or bellows shaped members together e.g. by stitching, welding etc.

1. A ballistic collar, comprising a body armour fabric folded into a structure with successive strips that run over into each other by folds of the fabric, the folds running substantially perpendicularly to an axial direction of the collar, whereby the collar may be expanded or compressed by increasing or decreasing fold angles between the strips at the folds.

2. A ballistic collar according to claim 1, wherein the structure comprises a plurality of piled sheets of body armour fabric, commonly folded into said structure.

3. A ballistic collar according to claim 1, wherein the fabric, is included in a matrix, with sufficient stiffness to cause the structure to stand up freely in a compressible position with non-zero fold angles, keeping the fabric folded according to said structure.

4. A ballistic collar according to claim 3, wherein the matrix comprises a resilient resin.

5. A ballistic collar according to claim 1, wherein the body armour fabric comprises aromatic polyamide fibers.

6. A ballistic collar according to claim 5, wherein the body armour fabric comprises ultra high molecular weight polyolefin (UHMWPO) fibers.

7. A ballistic collar according to claim 5, wherein the body armour fabric comprises ultra high molecular weight polyethylene (UHMWPE) fibers.

8. A ballistic collar according to claim 5, wherein the body armour fabric comprises ultra high molecular weight polypropylene (UHMWPP) fibers.

9. A ballistic collar according to claim 1, wherein the structure is a bellows shaped structure.

10. A ballistic collar according to claim 9, wherein the structure is a bellows shaped structure which is arranged to surround a human's neck.

11. A ballistic collar according to claim 10, the structure having plies of the bellows shape mainly perpendicular to the axis of the collar or of the human's neck.

12. A method of manufacturing a ballistic collar according to claim 1, comprising
providing a sheet of body armour fabric;
providing a mold arranged for sheet transformation, having a shape that defines the positions of the strips and folds; and
performing transformation of the sheet at a temperature and pressure at which the sheet is plastically deformable.

13. Method according to claim 12, comprising:
transforming parts of the collars or bellows shaped members; and
assembling the parts of the collars or bellows shaped members together.

14. Method according to claim 13, wherein the assembling step includes one of stitching and welding.

15. A ballistic collar according to claim 2, wherein the plurality of piled sheets is included in a matrix, with sufficient stiffness to cause the structure to stand up freely in a compressible position with non-zero fold angles, keeping the fabric folded according to said structure.
